(19) United States
(12) Patent Application Publication
(10) Pub. No.: US 2010/0153687 A1
(43) Pub. Date: Jun. 17, 2010

(54) STREAMING PROCESSOR, OPERATION METHOD OF STREAMING PROCESSOR AND PROCESSOR SYSTEM

(75) Inventors: Satoshi Koda, Tokyo (JP); Hiroaki Sugita, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/637,343

(22) Filed: Dec. 14, 2009

(30) Foreign Application Priority Data
Dec. 15, 2008 (JP) 2008-138665

(51) Int. Cl. G06F 15/76; G06F 9/02

(52) U.S. Cl. 712/36; 712/E09.002

(57) ABSTRACT

There is provided a streaming processor which includes one general-purpose processor core and multiple operation processor cores and which performs parallel processing by assigning multiple processes of decoding processing of an encoded stream to the operation processor cores. The streaming processor performs stream analysis processing for estimating a processing load for each stream on the basis of stream information and assigning processes to be performed by the operation processor cores on the basis of the estimated processing load.

### CROSS REFERENCE TO RELATED APPLICATION

This application claims the benefit of Japanese Application No. 2008-318665 filed in Japan on Dec. 15, 2008, the contents of which are incorporated herein by this reference.

### BACKGROUND OF THE INVENTION

1. Field of the Invention

The present invention relates to a multi-core streaming processor configured to perform parallel processing of streams, an operation method of the streaming processor and a processor system including the streaming processor.

2. Description of the Related Art

In distribution of a digital motion picture, for example, in digital TV broadcast, efficient encoding techniques, including data compression, are indispensable in order to reduce the band required for data transmission. For example, “H.264”, which is the standard of compression encoding methods for motion picture data and which was recommended by the International Telecommunications Union in May 2003 is widely used for digital TV broadcast and the like, as an encoding method.

An encoded digital motion picture is decoding-processed by a receiver and displayed on a display device. FIG. 1 is a diagram for illustrating a decoding process of a stream encoded by H.264, that is, continuous image data, audio data and the like. That is, the H.264 encoded stream is outputted as a decoded stream after receiving multiple processes such as entropy decoding process S10, inverse quantization process S11, inverse DCT process S12, motion compensation process S13 and memory storage process S14. The processes described above are performed by a processor executing programs for the processes.

In the decoding process, a distributed stream has to be processed on a real-time basis. A streaming processor has been developed which performs, using a multi-core processor having one general-purpose processor core and multiple operation processor cores, parallel processing by assigning multiple processes of the decoding process to the operation processor cores in order to perform processing within a limited time.

For example, a processor system 101 shown in FIG. 2 includes an input device 102, an output device 103 and a streaming processor 110. The streaming processor 110 is a multi-core processor having one general-purpose processor 111 and seven operation processor cores 112A to 112G. The streaming processor 110 performs assignment processing for assigning a stream separation process to the operation processor core 112A, decoding process A to the operation processor cores 112B to 112D, decoding processes B and C to the operation processor core 112E, decoding process D to the operation processor core 112F, and an audio decoding process to the operation processor core 112G.

Here, each of the decoding processes A to D corresponds to any of the processes including the entropy decoding process, described with reference to FIG. 1. That is, the processes of a decoding process, such as the entropy decoding process, the inverse quantization process and the motion compensation process are divided as separate programs. The streaming processor 110 realizes high-speed real-time decoding processing by reading the divided processing programs into the memories of the separate operation processor cores and causing the multiple operation processor cores to operate in parallel.

In the streaming processor 110, it is determined in advance which process of the decoding process is to be assigned to which of the operation processor cores 112A to 112G. However, since the processing load of an encoded stream is not known until decoding process of the stream is started, assignment of cores is determined on the basis of a stream with the maximum load which may be inputted. Therefore, when a stream with a low processing load is inputted, the operation processor cores are not effectively used.

FIG. 3 is a diagram for illustrating the use state of the processor cores 112 in the streaming processor 110. In FIG. 3, an operation core 12A, which is a stream separation section, performs processing for separating video and audio in a stream, and an audio decoding section performs decoding processing of the audio in the stream.

As shown in FIG. 3, in a stream 1, the processing load of the decoding process A is low, and space occurs in the operation processor cores 112C and 112D. In a stream 2, the load of the decoding process A is high, and the three operation processor cores 112B to 112D are used at a maximum. However, in the operation processor cores 112E and 112F, the processing load is low and waste occurs.

As described above, in the conventional streaming processor 110 and processor system 101, the original performance of the processor cannot be sufficiently shown, for example, because other programs cannot be executed even when there is space in operation processor cores, and there is a possibility that decoding processing of stream data cannot be efficiently performed.

### BRIEF SUMMARY OF THE INVENTION

A streaming processor of an embodiment of the present invention is a streaming processor configured to perform decoding processing of an encoded stream, includes: one general-purpose processor core and multiple operation processor cores configured to perform in parallel multiple processes constituting the decoding processing; wherein the streaming processor performs stream analysis processing which includes load estimation processing for estimating a processing load for each stream on the basis of stream information about the stream and assignment processing for assigning the processes to be performed by the operation processor cores on the basis of the estimated processing load.

An operation method of a streaming processor of another embodiment of the present invention is an operation method of a streaming processor configured to perform decoding processing of an encoded stream, wherein the streaming processor includes one general-purpose processor core and multiple operation processor cores configured to perform in parallel multiple processes constituting the decoding processing; and the operation method includes: separating the stream which has been inputted, into an H.264 stream and an audio stream; analyzing a NAL unit in the separated H.264 stream to acquire stream information; estimating a processing load for each of multiple processes for performing decoding processing of the H.264 stream; determining the number of necessary operation processor cores on the basis of an estimated maximum processing load; assigning the processes to be performed by the operation processor cores; and subjecting the operation processor cores to perform the processes.

A processor system of still another embodiment of the present invention includes: a streaming processor configured to perform decoding processing of an encoded stream having: one general-purpose processor core and multiple operation processor cores configured to perform in parallel multiple processes constituting the decoding processing, wherein the streaming processor performs stream analysis processing which includes load estimation processing for estimating a processing load for each stream on the basis of stream information about the stream and assignment processing for assigning the processes to be performed by the operation processor cores on the basis of the estimated processing load; an input device configured to input the encoded stream to the streaming processor; an output device configured to output a decoded stream inputted from the streaming processor; and a storage device configured to store programs for the multiple processes, a table for correspondence between the stream information and the processing load, and a table for correspondence between the processing load and the number of the operation processor cores to be used.

### BRIEF DESCRIPTION OF THE DRAWINGS

FIG. 1 is a diagram for illustrating a decoding process of a stream encoded by H.264;

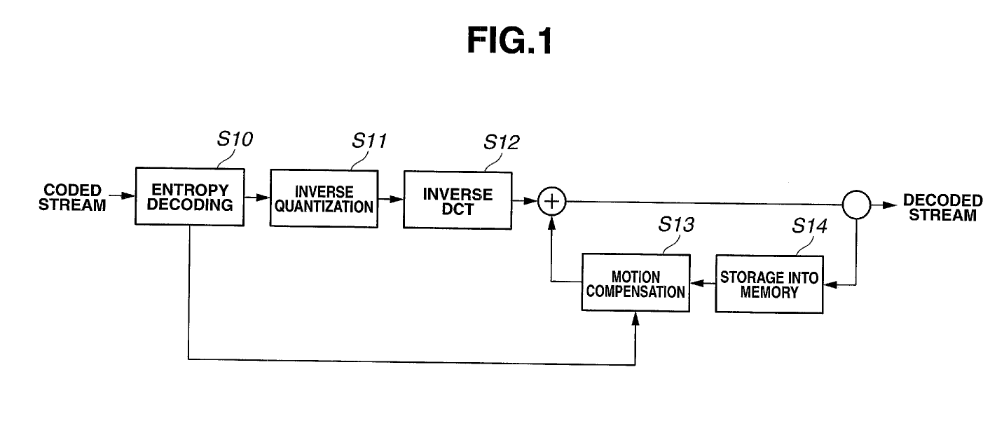

FIG. 2 is a diagram for illustrating the configuration and processing arrangement of a well-known processor system;

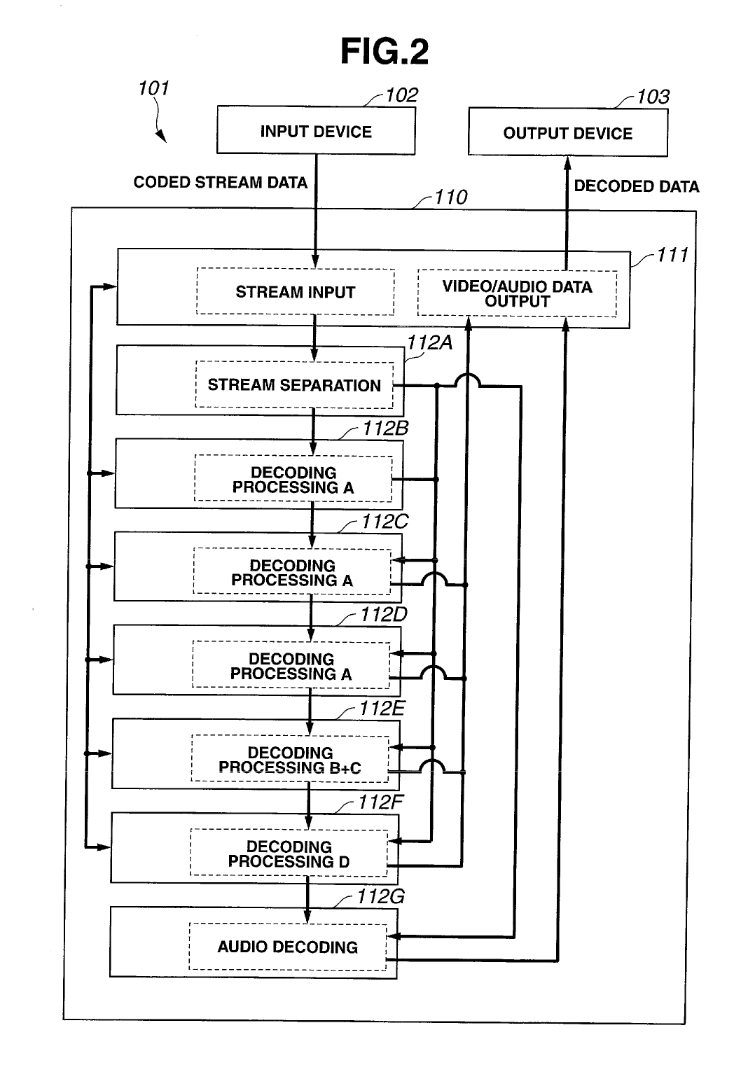

FIG. 3 is a diagram for illustrating the processing arrangement of operation cores of the well-known processor system;

FIG. 4 is a configuration diagram showing the configuration of a streaming processor and a processor system of a first embodiment of the present invention;

FIG. 5 is a flowchart for illustrating the flow of the operation of the streaming processor of the first embodiment of the present invention;

FIG. 6 is a diagram showing an example of assignment of operation processor cores in the streaming processor of the first embodiment of the present invention;

FIG. 7 is a flowchart for illustrating the flow of the operation of information acquisition processing by a stream information analysis section of the streaming processor of the first embodiment of the present invention;

FIG. 8 is a diagram showing an example of a parameter/processing load correspondence table of the streaming processor of the first embodiment of the present invention;

FIG. 9 is a diagram showing an example of a processing load/number of used cores correspondence table of the streaming processor of the first embodiment of the present invention;

FIG. 10 is a diagram for illustrating the use state of operation processor cores in a streaming processor and a processor system of a first variation example of the first embodiment of the present invention; and

FIG. 11 is a diagram for illustrating the use state of operation processor cores in a streaming processor and a processor system of a second variation example of the first embodiment of the present invention.

### DETAILED DESCRIPTION OF THE INVENTION

### First Embodiment

A streaming processor 10 and a processor system 1 of a first embodiment of the present invention will be described below with reference to drawings.

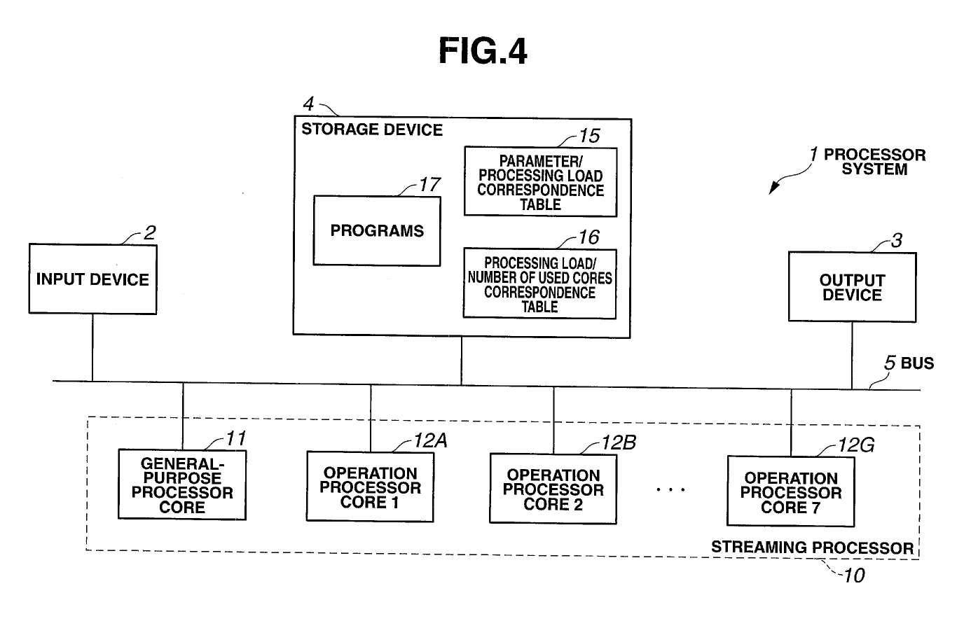

As shown in FIG. 4, the processor system 1 includes an input device 2, an output device 3, a storage device 4 and the streaming processor 10. The streaming processor 10 includes one general-purpose processor core (hereinafter, also referred to as a “general-purpose core”) 11 and seven operation processor cores (hereinafter, also referred to as “operation cores”) 12A to 12G. The streaming processor 10 performs parallel processing by dividing a decoding process of encoded stream data into multiple processes and assigning the divided processes to the general-purpose core and the operation cores 12A to 12G. Hereinafter, the operation cores 12A to 12G will be generically referred to as operation cores 12.

The storage device 4 stores programs 17 for processes divided and assigned to the operation cores 12, a parameter/processing load correspondence table 15 and a processing load/number of used cores correspondence table 16. The general-purpose core 11 performs processing for a program having a stream input function, a video/audio output function and the like to be read into a memory not shown. Each of the operation cores 12 performs processing for each of programs having other functions to be read into the memory not shown. In addition, as shown in FIG. 4, the input device 2, the storage device 4, the output device 3, and the streaming processor 10 are connected to one another through a bus 5.

The streaming processor 10 is a multi-core processor having the one general-purpose core 11 and the seven operation cores 12A to 12G. However, the numbers of the processor cores are not limited to the numbers in the present embodiment.

For example, the input device 2 is a receiving section of a digital high-vision TV broadcast receiver or a hard disk recorder having a digital high-vision TV broadcast receiving function, the output device 3 is a monitor or a speaker, and the storage device 4 is a hard disk device.

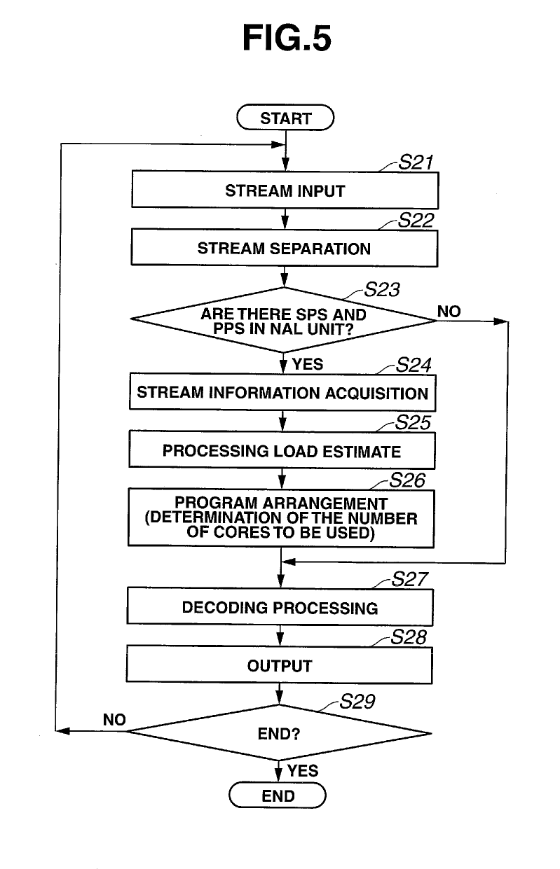

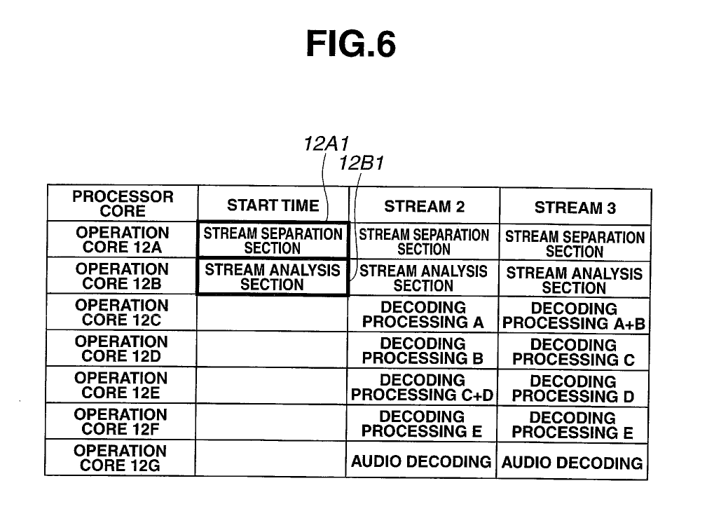

Next, the operation of the streaming processor 10 and the processor system 1 of the present embodiment will be described with the use of FIGS. 5 and 6.

Description will be made in accordance with the flowchart in FIG. 5.

### <Step S21> Stream Input Step

Encoded stream data is inputted to the streaming processor 10 via the input device 2 and the general-purpose core 11.

### <Step S22> Stream Separation Step

The encoded stream inputted to the streaming processor 10 is sent to a stream separation section of the operation core 12A and separated into an H.264 stream and an audio stream. As shown under “start time” in FIG. 6, a program having a stream separation function stored in the storage device 4 has been read into the memory of the operation core 12A, and the operation core 12A is ready to operate as a stream separation section 12A1, and a program having a stream analysis function has been read into the memory of the operation core 12B, and the operation core 12B is ready to operate as a stream analysis section 12B1. As for the operation cores 12 below also, the programs 17 for performing the functions, which are stored in the storage device 4, are read into the memories of the operation cores 12 and operate as processing sections.

The separated H.264 stream and audio stream are sent to the stream analysis section 12B1 of the operation core 12B and an audio decoding section of the operation core 12G, respectively.

### <Step S23> Stream Analysis Step 1

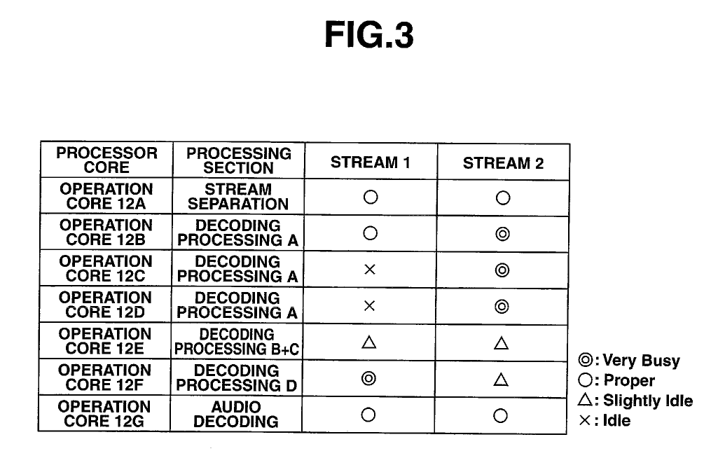

The stream analysis section 12B1 configured to perform stream analysis processing confirms whether an SPS parameter and a PPS parameter are included in a NAL unit, from the H.264 stream. If the parameters are not included (No), then, for example, each program is read into each memory in accordance with predetermined assignment of the programs 17 to the operation cores 12 as shown in FIG. 3, to perform processing, or processing is performed in accordance with a program already read in each of the operation cores 12.

### <Step S24> Stream Analysis Step 2

If the SPS parameter and the PPS parameter are included in the NAL unit (S23: Yes), then the stream analysis section 12B1 performs decoding processing only of the NAL unit and takes out parameter information which is added information. The operation of the stream analysis section 12B1 will be described later in detail with reference to FIG. 6.

### <Step S25> Processing Load Estimation Step

The stream analysis section 12B1 estimates the maximum processing load of the inputted stream with the use of acquired stream information on the basis of the parameter/processing load correspondence table 15. In the following description, “processing load on each processor cores at the time of processing each stream” will be described “stream load”. Together with a stream analysis program, the program 17 is read into a memory section of one operation core 12C from the storage device 4, and the program 17 operates and measures the processing load of each process for multiple streams with different parameters. On the basis of the result of the measurement, the parameter/processing load correspondence table 15 is created and stored into the operation core 12C.

For example, in the case of a 30 fps stream input, the processing load of each process refers to the sum total of the number of instruction cycles required for decoding processing of thirty frames, and the unit is “cycles/sec”.

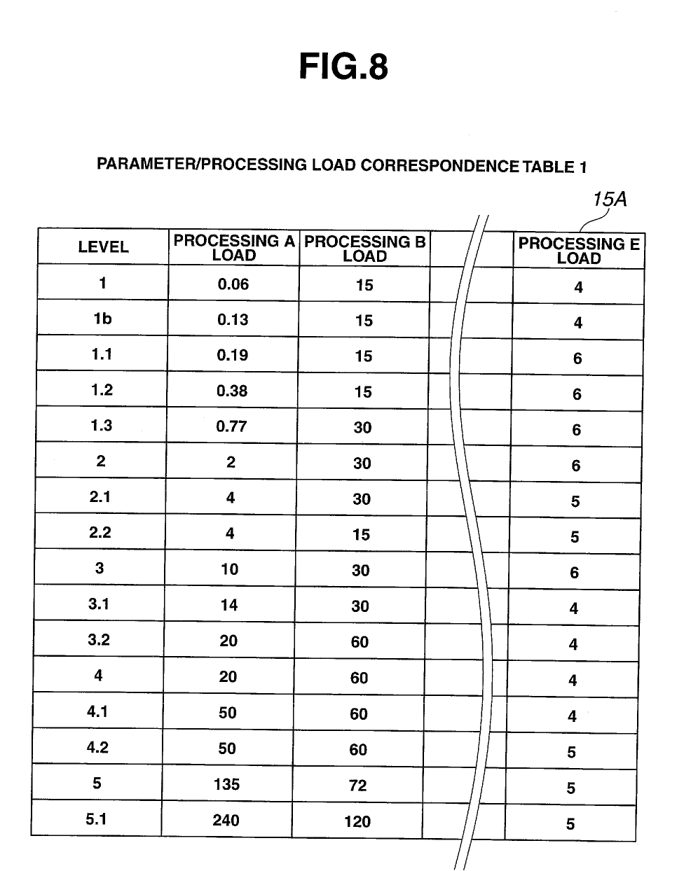

For example, if the processing loads of processes are the values as shown below in the case where a level 4.1 stream is decoded, then the values shown below immediately constitute the parameter/processing load correspondence table 15 as shown in FIG. 8.

Process A: 50 G cycles/sec

Process B: 60 G cycles/sec

. . .

Process E: 4 G cycles/sec

### <Step S26> the Number of Cores Determination Step

The stream analysis section 12B1 determines the minimum number of processor cores required for maintaining the performance for performing decoding processing of an inputted stream on a real-time basis, on the basis of the estimated maximum processing load and the processing load/number of used cores correspondence table 16. The processing load/number of used cores correspondence table 16 has been already read into the memory section of the operation core 12C from the storage device 4 together with the stream analysis program.

To explain this in greater detail, the processing load of the whole program and the ratio of the processing load of each process to the processing load of the whole program are calculated from the processing load measurement result obtained when the parameter/processing load correspondence table 15 is created. Then, from the result and the processing performance of the operation processor cores 12, the minimum number of used cores required by each process to maintain the real-time decoding processing performance is determined, and the processing load/number of used cores correspondence table 16 is created.

Specifically, when the processing load/number of used cores correspondence table 16 is created, the ratio of the processing load of each process to the load of the whole decoding process is calculated. That is, if the stream measurement result is as shown below, the decoding processing load for thirty frames is 10 G cycles/sec.

Process A: 3 G cycles/sec

Process B: 5 G cycles/sec

Process C: 0.8 G cycles/sec

Process D: 0.3 G cycles/sec

Process E: 0.9 G cycles/sec

Then, the decoding processing load ratios are as follows:

Process A: 30%

Process B: 50%

Process C: 8%

Process D: 3%

Process E: 9%

For example, in the case where the operating frequency of the operation cores 12 is 2.0 GHz, and processing corresponding to 2 G cycles can be executed per second, the minimum number of operation cores required to decode a stream with a processing load of 10 G cycles/sec on a real-time basis is 10 G/2 G=5. In this case, the number of cores assigned to each process, that is, the minimum number of used cores required by each process is calculated from the above ratios, as shown below.

Process A=5×0.3=1.5

Process B=5×0.5=2.5

Process C=5×0.08=0.4

Process D=5×0.03=0.15

Process E=5×0.09=0.45

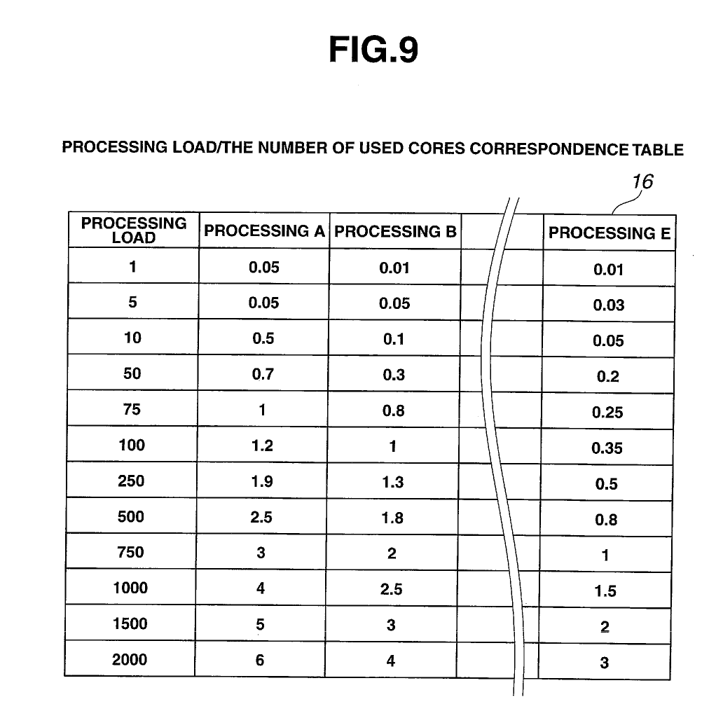

The stream analysis section 12B1 assigns decoding processing to be performed by each of the operation cores 12. That is, as for the stream 1 shown in FIG. 9, the decoding process A is assigned to the operation core 12C, the decoding process B is assigned to the operation core 12D, the decoding processes C and D are assigned to the operation core 12E, and the decoding process E is assigned to the operation core 12F.

### <Step S27> Decoding Processing Step

The operation cores 12 perform decoding processing in parallel as processing sections of the read programs.

### <Step S28> Output Step

The streaming processor 10 outputs decoded data, that is, stream video data and audio data, to the output device 3 via the general-purpose core 11 after synchronizing output timings.

### <Step S29> Repetition Processing

The streaming processor 10 repeats the above stream processing until an end instruction is given.

As described above, in the streaming processor 10 and the processor system 1 of the present embodiment, optimum processing arrangement is performed for each stream, and therefore, it is possible to efficiently perform decoding processing of stream data.

Next, the flow of the operation of information acquisition processing by a stream information analysis section of the streaming processor 10 of the present embodiment will be described in detail.

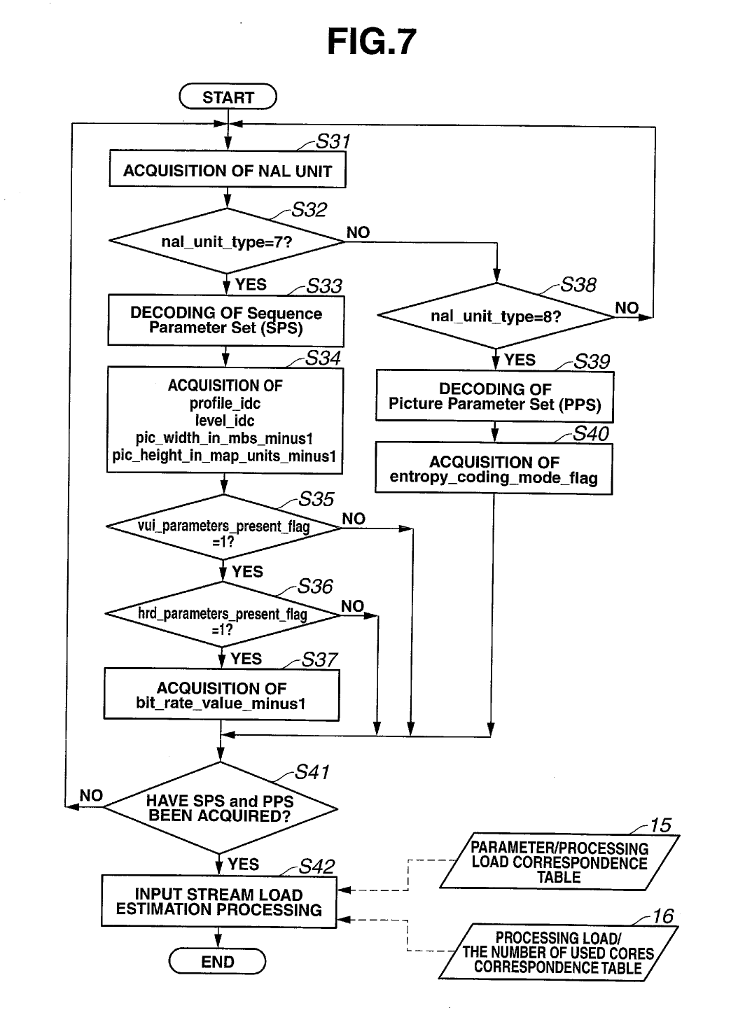

Description will be made in accordance with the flowchart in FIG. 7.

### <Step S31> NAL Unit Acquisition Step

As already described, the stream analysis section 12B1 of the operation core 12C of the streaming processor 10 acquires a NAL (Network Abstraction Layer) unit from an H.264 stream. The NAL unit includes various pieces of information about the stream. The streaming processor 10 estimates a processing load using a profile, a level, a macroblock size and an entropy coding mode. In the case where a bit rate is included in the NAL unit as the stream information, the streaming processor 10 estimates the processing load using the bit rate also.

### <Steps S32 to S37> SPS Parameter Acquisition Step

When a stream is inputted, the stream analysis section 12B1 acquires a NAL unit included in the stream and (NAL_unit_type) associated with the NAL unit.

If the value of NAL_unit_type of the NAL unit equals to 7, the NAL unit includes a sequence parameter set (hereinafter referred to as “SPS”). Therefore, the stream analysis section 12B1 performs decoding processing of the SPS and acquires the values of the included profile (profile_idc), level (level_idc) and macroblock size (pic_width_in_mbs_minus1, pic_height_map_units_minus1). Here, the macroblock is a block with 16×16 pixels, which is a processing unit in H.264. The macroblock size is the number of blocks constituting video, that is, a video size.

If the value of (vui_parameters_present_flag) included in the SPS equals to 1, and both or any one of (nal_hrd_parameters_present_flag) and (vcl_hrd_parameters_present_flag) exist(s) in the SPS and the value(s) equals to 1, then the stream analysis section 12B1 acquires the value of the bit rate (bit_rate_value_minus1) existing in the SPS.

That is, the bit rate is not indispensable information as the stream information used for the streaming processor 10 to perform processing load estimation processing.

### <Steps S38 to S40> PPS Parameter Acquisition Step

If the value of (NAL_unit_type) equals to 8, the NAL unit includes a picture parameter set (hereinafter referred to as “PPS”). Therefore, the stream analysis section 12B1 performs decoding processing of the PPS and acquires the value of the included entropy coding mode (entropy_coding_mode_flag).

### <Step S41>

When decoding processing of both of the SPS and the PPS and acquisition of necessary parameters included in the SPS and the PPS are completed, the stream analysis section 12B1 performs input stream load estimation processing at step S42. If only any one of the SPS and the PPS has been completed, the stream analysis section 12B1 acquires a next NAL unit included in the stream.

### <Step S42> Processing Load Estimation Processing Step

In the input stream load estimation processing, the stream analysis section 12B1 estimates a stream load corresponding to the combination of the parameters acquired from the SPS and the PPS, on the basis of the parameter/processing load correspondence table 15. As the parameters, that is, as the stream information, the profile, the level, the macroblock size and the entropy coding mode are indispensable information. When bit rate information can be obtained, the stream analysis section 12B1 also uses the bit rate information for the load estimation processing.

For example, as shown in FIG. 8, the parameter/processing load correspondence table 15A is a table showing processing loads for the level, which is one of parameters of a stream. That is, the processing load is low at a level 1, and the processing load increases as the level number increases. Similarly, there are also parameter/processing load correspondence tables 15 for the other parameters. The stream analysis section 12B1 estimates a load using the multiple parameter/processing load correspondence tables 15.

Furthermore, the stream analysis section 12B1 determines the number of used operation cores 12 corresponding to the estimated load, on the basis of the processing load/number of used cores correspondence table 16.

That is, as shown in FIG. 9, the number of used operation cores 12 corresponding to the processing load is shown in the processing load/number of used cores correspondence table 16.

Of course, the processing load/number of used cores correspondence table 16 and the parameter/processing load correspondence table 15 may be shown not in a tabular form but in an expression.

As described above, in the streaming processor 10 and the processor system 1 of the present embodiment, optimum processing arrangement is performed for each stream on the basis of the processing load/number of used cores correspondence table 16 and the parameter/processing load correspondence table 15, and therefore, it is possible to efficiently perform decoding processing of stream data.

### First Variation Example of the First Embodiment

A streaming processor and a processor system of a first variation example of the first embodiment of the present invention will be described below with reference to drawings. Since the streaming processor and the processor system of this variation example are similar to the streaming processor 10 and the processor system 1 of the first embodiment, the same description will be omitted.

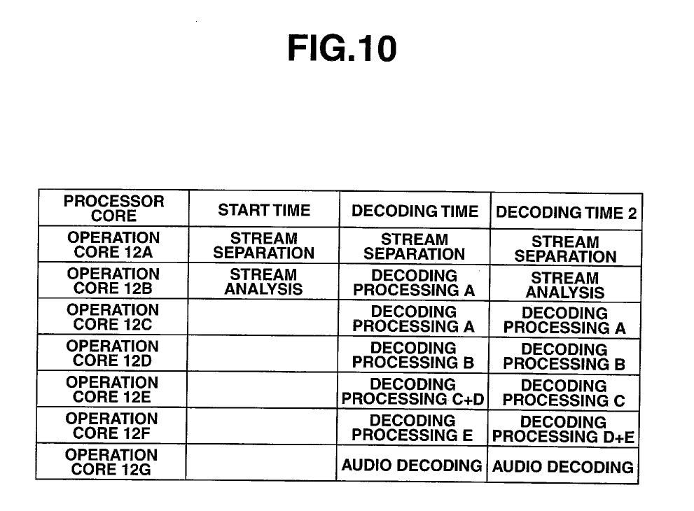

As shown in FIG. 10, in the streaming processor of this variation example, a stream analysis program has been already read into an operation core 12B and operates as a stream analysis section 12B1 at start time, similarly to the streaming processor 10 in the first embodiment. However, when the function of the stream analysis section 12B1 ends, the stream analysis section 12B1 is erased from the operation core 12B at decoding time, and the operation core 12B performs processing as a different decoding processing section A. As shown under “decoding time 2”, when the operation of the stream analysis section 12B1 is required again, the stream analysis program is read into the operation core 12B again and functions as the stream analysis section 12B1. Since stream analysis is performed for each stream, the use frequency is relatively low.

In addition to the advantages of the streaming processor 10 and the processor system 1 of the first embodiment, the streaming processor and the processor system of this variation example can perform decoding processing of stream data more efficiently.

### Second Variation Example of First Embodiment

A streaming processor and a processor system of a second variation example of the first embodiment of the present invention will be described below with reference to drawings. Since the streaming processor and the processor system of this variation example are similar to the streaming processor 10 and the processor system 1 of the first embodiment, the same description will be omitted.

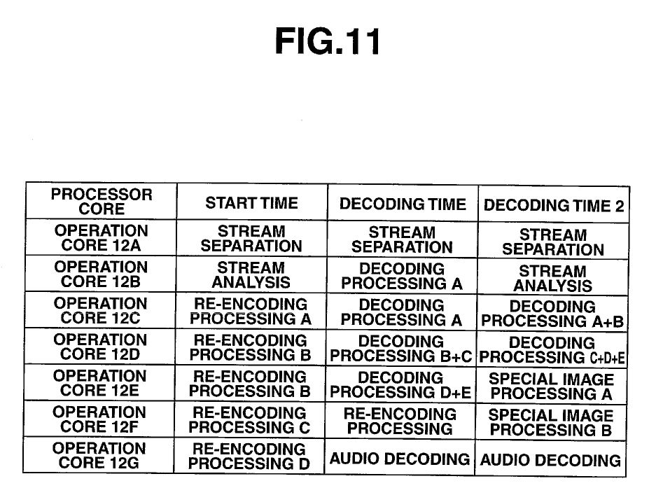

As shown in FIG. 11, in the streaming processor of this variation example, a stream analysis program has been already read into an operation core 12B and operates as a stream analysis section 12B1 at start time, that is, before decoding processing is started, similarly to the streaming processor 10 in the first embodiment. Furthermore, in the streaming processor of this variation example, operation cores 12C to 12G which are not used because decoding processing is not started are used for re-encoding processing. In general, video streams which have been decoding-processed are stored in a hard disk recorder and the like. The occupied storage capacity can be reduced by performing re-encoding processing and re-storage. Therefore, in the streaming processor of this variation example, if there is any operation core 12 which is not used for decoding processing, in other words, real-time processing, the operation core 12 is used to perform best-effort process processing other than the decoding processing.

Furthermore, in the streaming processor of this variation example, if there is any such an operation core 12 that the stream load is low even during decoding time and that is not used for decoding processing, the operation core 12 is used to perform signal processing other than the decoding processing, as shown under “decoding time” in FIG. 11. Furthermore, in the streaming processor of this variation example, it is possible to perform, in addition to the decoding processing, special image processing, for example, real-time processing such as highlighting of a target to be noticed, in accordance with a user instruction, as shown under “decoding time 2” in FIG. 11. In the streaming processor of this variation example, it is also possible to perform decoding processing of two streams at the same time.

However, when the function of the stream analysis section 12B1 ends, the stream analysis section 12B1 is erased from the operation core 12B at decoding time, and the operation core 12B performs processing as a different decoding processing section A. As shown under “decoding time 2”, when the operation of the stream analysis section 12B1 is required again, the stream analysis program is read into the operation core 12B again and functions as the stream analysis section 12B1. Of course, the operation core 12 operating as the stream analysis section 12B1 is not limited to the operation core 12B. A different operation core 12 may be used.

In addition to the advantages of the streaming processor 10 and the processor system 1 of the first embodiment, the streaming processor and the processor system of this variation example can perform decoding processing of stream data more efficiently.

In addition to the advantages of the streaming processor 10 and the processor system 1 of the first embodiment, the streaming processor and the processor system of this variation example can perform decoding processing of stream data more efficiently. Furthermore, the streaming processor can be utilized for so-called best-effort process processing other than decoding processing, which is real-time processing. Furthermore, in the case where only processing with a low load is performed, there may be an operation core 12 which does not load a processing program. Since an operation core 12 which is not used at all does not consume power almost at all, the power consumption of the whole processor system can be reduced.

In the streaming processor and the processor system of the present invention, an upper limit of the number of operation cores 12 to be used by each decoding process may be set with the use of a so-called processor pool function. It is also possible to pool the number of cores to be used by the whole decoding process and perform the decoding process and processes other than the decoding process, balancing the decoding process and the other processes. It is also possible for the stream analysis section 12B1 to estimate a processing load for performing the whole decoding process, calculate the number of operation cores 12 for performing the whole decoding process and perform assignment processing prior to best-effort process processing.

Description has been made with H.264-coding-processed data as an example. However, the advantages of the present invention can be also obtained even in the case of other encoded data, for example, MPEG-4, MPEG-2 and VC1 data if the data is an encoded stream.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A streaming processor configured to perform decoding processing of an encoded stream, comprising:
one general-purpose processor core and multiple operation processor cores configured to perform in parallel multiple processes constituting the decoding processing; wherein
the streaming processor performs stream analysis processing which includes load estimation processing for estimating a processing load for each stream on the basis of stream information about the stream and assignment processing for assigning the processes to be performed by the operation processor cores on the basis of the estimated processing load.

2. The streaming processor according to claim 1, wherein
the processing load is estimated from a table for correspondence between the stream information and the processing load; and
the assignment processing is performed on the basis of a table for correspondence between the processing load and a number of the operation processor cores to be used.

3. The streaming processor according to claim 2, wherein
the stream is data which has been encoding-processed by an H.264 method; and
the stream information includes a profile, a level, a macroblock size and an entropy coding mode.

4. The streaming processor according to claim 3, wherein the stream information further includes a bit rate.

5. The streaming processor according to claim 4, wherein the stream is data for digital TV broadcast.

6. The streaming processor according to claim 5, wherein
at least one of the operation processor cores is used for the decoding processing of audio data of the stream, and the other multiple operation processor cores are used for the decoding processing of image data; and
the stream analysis processing is performed for the decoding processing of the image data.

7. The streaming processor according to claim 6, wherein the operation processor cores which perform the stream analysis processing perform any of the processes of the decoding processing after the stream analysis processing ends.

8. The streaming processor according to claim 7, wherein the operation processor cores which are not assigned the processes by the stream analysis processing perform signal processing other than the processes.

9. The streaming processor according to claim 8, wherein the signal processing is re-encoding processing or special image processing.

10. An operation method of a streaming processor configured to perform decoding processing of an encoded stream, wherein
the streaming processor comprises one general-purpose processor core and multiple operation processor cores configured to perform in parallel multiple processes constituting the decoding processing; and
the operation method comprises:
separating the stream which has been inputted, into an H.264 stream and an audio stream;
analyzing a NAL unit in the separated H.264 stream to acquire stream information;
estimating a processing load for each of multiple processes for performing decoding processing of the H.264 stream;
determining the number of necessary operation processor cores on the basis of an estimated maximum processing load;
assigning the processes to be performed by the operation processor cores; and
subjecting the operation processor cores to perform the processes.

11. The operation method of the streaming processor according to claim 10, the operation method comprising:
estimating the processing load from a table for correspondence between the stream information and the processing load; and
performing the assignment on the basis of a table for correspondence between the processing load and a number of the operation processor cores to be used.

12. The operation method of the streaming processor according to claim 11, wherein the stream information includes a profile, a level, a macroblock size and an entropy coding mode.

13. The operation method of the streaming processor according to claim 12, wherein the stream information further includes a bit rate.

14. The operation method of the streaming processor according to claim 13, wherein the stream is data for digital TV broadcast.

15. The operation method of the streaming processor according to claim 14, wherein
at least one of the operation processor cores is used for the decoding processing of audio data of the stream, and the other multiple operation processor cores are used for the decoding processing of image data; and
the stream analysis is performed for the decoding processing of the image data.

16. The operation method of the streaming processor according to claim 15, wherein the operation processor cores which perform the stream analysis processing perform any of the processes of the decoding processing after the stream analysis processing ends.

17. The operation method of the streaming processor according to claim 16, wherein the operation processor cores which are not assigned the processes by the stream analysis processing perform signal processing other than the processes.

18. The operation method of the streaming processor according to claim 17, wherein the signal processing is re-encoding processing or special image processing.

19. A processor system comprising:
a streaming processor configured to perform decoding processing of an encoded stream having:
one general-purpose processor core and multiple operation processor cores configured to perform in parallel processes constituting the decoding processing, wherein
the streaming processor performs stream analysis processing which includes load estimation processing for estimating a processing load for each stream on the basis of stream information about the stream and assignment processing for assigning the processes to be performed by the operation processor cores on the basis of the estimated processing load;
an input device configured to input the encoded stream to the streaming processor;
an output device configured to output a decoded stream inputted from the streaming processor; and
a storage device configured to store programs for the multiple processes, a table for correspondence between the stream information and the processing load, and a table for correspondence between the processing load and a number of the operation processor cores to be used.

20. The processor system according to claim 19, wherein
the encoded stream is data for digital TV broadcast which has been encoding-processed by an H.264 method;
the stream information includes a profile, a level, a macroblock size and an entropy coding mode;
the processing load is estimated from a table for correspondence between the stream information and the processing load; and
the assignment processing is performed on the basis of a table for correspondence between the processing load and a number of the operation processor cores to be used.
